(19) United States
(12) Patent Application Publication
(10) Pub. No.: US 2010/0186207 A1
(43) Pub. Date: Jul. 29, 2010

(54) Multi-Seal Casket

(76) Inventors: Kyle D. Moore, Tucson, AZ (US); Michael Omstead, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 12/359,908

(22) Filed: Jan. 26, 2009

(51) Int. Cl. A61G 17/00; A61G 17/08; A61G 17/02

(52) U.S. Cl. 27/1; 27/17

(57) ABSTRACT

A casket or urn container having a multiple seal arrangement that provides for easy sealing and essentially permanent closure of the container. A redundant sealing system is provided to ensure that an initial seal breach does not allow the interchange of gases, solids, or liquids between the container and the external environment.

### BACKGROUND OF THE INVENTION

1. Field of the Invention

The invention relates generally to improved apparatus for bodily remains, and, more particularly, to caskets featuring multiple sealing means.

2. Description of the Related Art

Caskets for protecting bodily remains come in a large variety of configurations and options. Nonetheless, for specialized funerary needs, such as for the departure of a pet, a fairly limited number of caskets and urns are available to house a pet's body or ashes. Undertakers or other professions typically handle all of the body placement arrangements for departed human beings. However, because the passing of a pet often is attended to directly by the pet owner, there is a need for easy to use and seal caskets and urns that remain closed and sealed from the environment, whether stored above ground or interred in the earth.

Typical caskets contain a seal (such as a gasket) and a body support system. For example, U.S. Pat. No. 5,722,133 and U.S. Pat. No. 5,568,677 both disclose caskets that have seals. Moreover, U.S. Pat. No. 3,918,133 illustrates a body support system. Some caskets even provide a vacuum seal. Thus, U.K. Patent Application 2 287 695 discloses a casket that is vacuum sealed through a one-way valve.

While these caskets may be suitable for their intended purpose, they can be prone to user error in the form of mis-sealing. The consequences of not properly sealing a body in a casket are, of course, undesirable. If a leaky casket is buried in an area subject to roaming animals, the interred body may be detected and casket dug up. Moreover, those who would prefer (or perhaps have no choice due to the lack of a permanent residence, such as a retiree who travels and lives in a recreational vehicle) to keep the remains of a pet unburied should ideally have a casket that seals in a practically permanent and foolproof manner.

Accordingly, it would be desirable to provide a casket and urn that can be easily sealed by a novice and stay that way whether buried in the ground or stored elsewhere.

### SUMMARY OF THE INVENTION

The invention generally involves a casket or urn container having a unique multiple seal arrangement that provides for easy sealing and essentially permanent closure of the container. Moreover, a redundant sealing system is provided to ensure that an initial seal breach does not allow the interchange of gases, solids, or liquids between the container and the external environment.

Thus, there is provided new and improved casket or urn container that is especially useful for use by the owner of a pet whose remains are to be stored.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts an embodiment of the invention.

FIG. 2 shows the embodiment of FIG. 1 in sealed arrangement.

FIG. 3 schematically depicts in elevational view a close-up view of the top and bottom sealing surfaces of the embodiment of FIG. 1.

FIG. 4 is an enlarged cross-sectional view of the top and bottom sealing surfaces of a second embodiment of the invention.

### DETAILED DESCRIPTION OF THE PREFERRED EMBODIMENTS

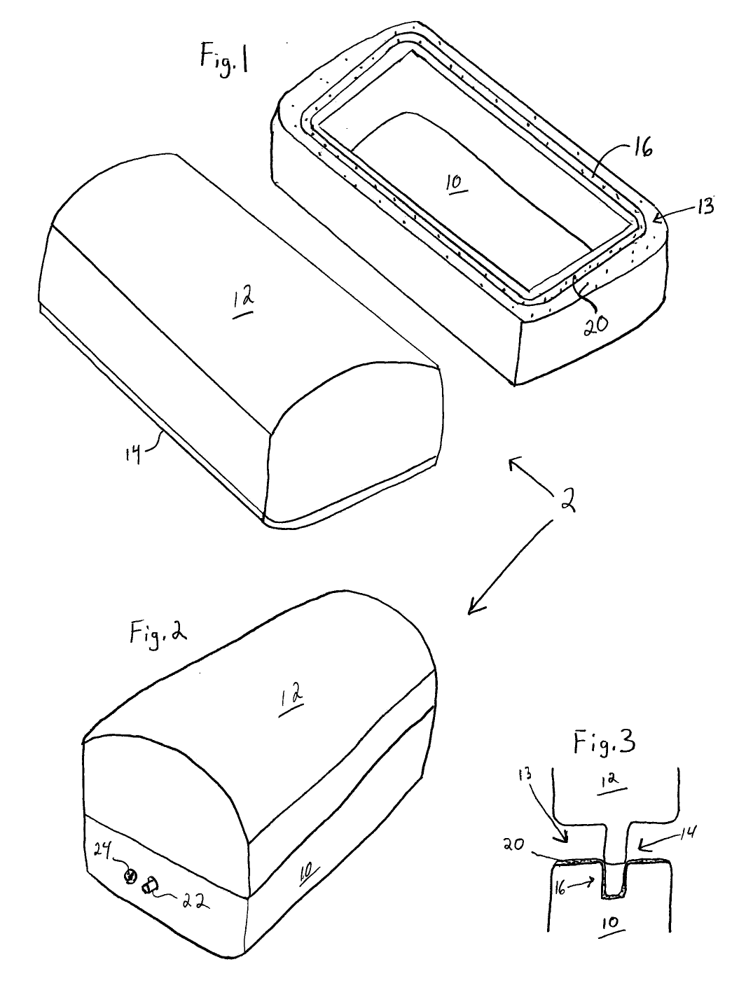

Turning to a first embodiment of the invention as shown in FIG. 1, a casket or urn container 2 has a bottom piece 10 and a top piece 12. The bottom and top pieces are adapted to be coupled in permanent sealed arrangement (as shown in FIG. 2) through two sealing members concentrically disposed about an interface 13 between the bottom and top pieces. In this embodiment, first sealing member includes tongue 14 and groove 16 that form a joint, with the second sealing member being adhesive 20.

Thus, the casket or urn container 2, has two sealing members (tongue-and-groove 14/16 and adhesive 20) disposed continuously along a perimeter of the interface 13 between the bottom 10 and top 12 pieces. The container of the invention is easy to seal, and having redundant sealing members provides a measure of “fool proofing” and assurance that container will not leak or open, especially if it is sealed by an ordinary consumer for his or her pet remains.

As shown in sealed arrangement in FIG. 2, the casket or urn container 2 may further include a one-way valve 22 through which air is evacuated from the interior and a plug 24. In order to seal the container more effectively, plug 24 is removed to allow air to escape during the placement of tongue 14 within groove 16. Plug 24 is replaced once the container 2 is sealed and further air may be evacuated from the container through one-way valve 22. Further evacuation of air provides a “vice-like” vacuum that holds top piece 12 to bottom piece 10 together such that adhesive 20 is spread over substantially all the interface 13 area, thereby promoting a more secure seal.

FIG. 3 schematically depicts in elevational view a close-up view of the top and bottom sealing surfaces of the embodiment of FIGS. 1 and 2. Hence, top piece 12 and bottom piece 10 are mated and sealed at interface 13 through tongue 14 press fitting into groove 16 and adhesive 20 (which is continuously disposed along interface 13 such that all surfaces are substantially covered and bonded thereby).

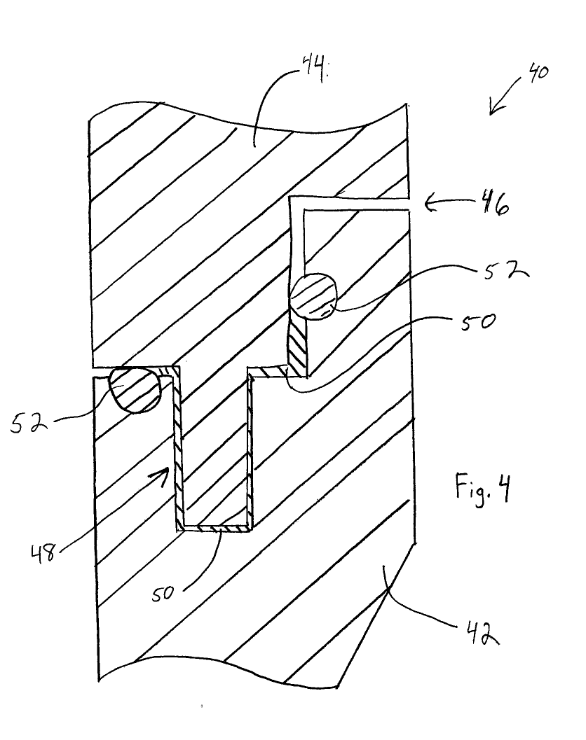

Turning to FIG. 4, an enlarged cross-sectional view of the top and bottom sealing surfaces of a second embodiment of the invention is shown. Here, the casket or urn container 40 includes a bottom piece 42 and a top piece 44 adapted to be coupled in permanent sealed arrangement, wherein the sealed arrangement has sealing members concentrically disposed about interface 46 between the bottom and top pieces. Preferably, the seals are continuous (i.e., there are no gaps in the seal) and include a tongue-and-groove joint 48, an adhesive 50 and/or one or more a gaskets 52.

In this embodiment, the adhesive 50 is disposed within the tongue-and-groove joint 48 and the gasket 52 is disposed exterior to and interior of the tongue-and-groove joint. Such an arrangement provides an excellent redundant (triple) seal without excess adhesive 50 seeping from the interface area 46.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products. All references cited in this application are hereby incorporated by reference herein.

What is claimed is:

1. A casket or urn container, comprising:
a bottom piece; and
a top piece adapted to be coupled in permanent sealed arrangement with said top piece, wherein said sealed arrangement comprises at least two sealing members concentrically disposed about an interface between said bottom and said top pieces.

2. The casket or urn of claim 1, wherein said at least two sealing members are disposed continuously along a perimeter of said interface between said bottom and said top pieces.

3. The casket or urn of claim 1, wherein said at least two sealing members comprise an adhesive and a gasket.

4. The casket or urn of claim 2, wherein said at least two sealing members comprise an adhesive and a gasket.

5. The casket or urn of claim 1, wherein said at least two sealing members comprise an adhesive and a tongue-and-groove joint.

6. The casket or urn of claim 2, wherein said at least two sealing members comprise an adhesive and a tongue-and-groove joint.

7. The casket or urn of claim 1, wherein said at least two sealing members comprise a tongue-and-groove joint and a gasket.

8. The casket or urn of claim 2, wherein said at least two sealing members comprise a tongue-and-groove joint and a gasket.

9. The casket or urn of claim 1, wherein said at least two sealing members comprise a tongue-and-groove joint, an adhesive, and a gasket.

10. The casket or urn of claim 2, wherein said at least two sealing members comprise a tongue-and-groove joint, an adhesive and a gasket.

11. The casket or urn of claim 1, further including a one-way valve through which air is evacuated from an interior of said casket or urn.

12. The casket or urn of claim 2, further including a removable plug and one-way valve through which air is evacuated from an interior of said casket or urn.

13. The casket or urn of claim 5, wherein said adhesive is disposed within said tongue-and-groove joint.

14. The casket or urn of claim 6, wherein said adhesive is disposed within said tongue-and-groove joint.

15. A casket or urn container, comprising:
a bottom piece; and
a top piece adapted to be coupled in permanent sealed arrangement with said top piece, wherein said sealed arrangement comprises at least three sealing members concentrically and continuously disposed about an interface between said bottom and said top pieces.

16. The casket or urn of claim 15, wherein said at least three sealing members comprise a tongue-and-groove joint, an adhesive and a gasket.

17. The casket or urn of claim 16, wherein said adhesive is disposed within said tongue-and-groove joint and said gasket is disposed exterior to the tongue-and-groove joint.

18. The casket or urn of claim 17, wherein said adhesive is disposed within said tongue-and-groove joint and said gasket is disposed exterior to the tongue-and-groove joint.

19. The casket or urn of claim 15, further including a removable plug and one-way valve through which air is evacuated from an interior of said casket or urn.

20. The casket or urn of claim 17, further including a second gasket, wherein said second gasket is disposed interior to the tongue-and-groove joint.
